(19) United States
(12) Patent Application Publication
(10) Pub. No.: US 2008/0010883 A1
(43) Pub. Date: Jan. 17, 2008

(54) Stick anywhere pocket invention

(76) Inventor: Joseph Morgese, Daytona Beach, FL (US)

Correspondence Address: JOSEPH MORGESE, SUITE 606, PMB 389, 1500 BEVILLE ROAD, DAYTONA BEACH, FL, 32114, US

(21) Appl. No.: 11/504,875

(22) Filed: Aug. 15, 2006

Related U.S. Application Data
(60) Provisional application No. 60/710,170, filed on Aug. 21, 2005.

(51) Int. Cl. G09F 3/18

(52) U.S. Cl. 40/654.01

(57) ABSTRACT

A convenient method for having extra pockets wherever one feels the need for one, that affix to any surface desired, so as to enhance the convenience of items at hand. Such method that would allow an advertising medium, whereby messages can be printed on them. Such method that would become a fashion accessory, when done in a fashion conscious and esthetic way.

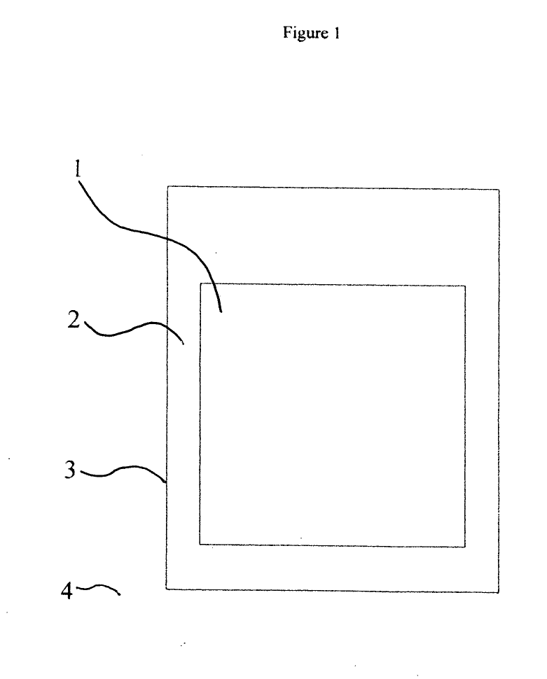

### CROSS-REFERENCE TO RELATED APPLICATIONS

This application claims the benefit of Provisional Patent Application Ser. No. 60/710,170, filed on Aug. 21, 2005

### BACKGROUND OF INVENTION

### Field Of Invention

This invention is in the garment accessories field and caters to the modern day needs of just about anyone that needs an extra pocket every now and then. Specifically, whenever you find yourself without a shirt pocket, to stick your glasses, cell-phone, loose change . . . etc . . . , but may also be stuck against walls, refrigerators, mirrors, automobile dashboards . . . etc . . .

### SUMMARY OF INVENTION

Basically, it is just the same as a shirt pocket that everyone is familiar with, except it is ‘stand alone’. It has a backing of material upon which the pocket is fastened to and the backing is made to stick to most any surface. This ‘Stick Anywhere Pocket’ helps an individual to keep items nearby, to help the person stay organized. It may be made of any material, even stiff material for wall applications. It may be disposable (such as paper or cardboard) or something more permanent, even esthetic, such as leather or velvet cloth or silk. It may stick using a medium coming from a group consisting of two-faced tape, temporary cloth adhesive (in that it is of a peel able non-permanent application) and velcro.

Also, it may be used as an advertising medium, whereby, companies, wishing to get their message out would give them away with their message printed on it.

### LIST OF REFERENCE NUMERALS

1—Pocket (actual)
2—Pocket (backing)
3—Adhesive on backside of (2) Pocket backing
4—The Surface upon which The Stick Anywhere Pocket is applied.

### DESCRIPTION OF DRAWING

The Stick Anywhere Pocket has the actual pocket (1) that is affixed to the backing (2) upon which the adhesive medium (3), (that may have a protective sheet that peels away when ready to be used), is located on the backside of (2) and whereby is stuck onto a surface (4).

The pocket (1) may be affixed to the backing (2) on the conventional three sides with the top side left open to insert items, or a modified version of the pocket (1) whereby less material is needed and can be a narrow band affixed to the backing on just the two sides and the top and the bottom are open, as this would accommodate hanging eyeglasses, clipping pens, paper clips . . . etc . . .

The Adhesive medium (3) can be modified for all sorts of applications using glues, magnets (for refrigerators), Velcro, two-faced tapes . . . etc . . . and for temporary or more permanent applications.

The materials of the pocket (1) and backing (2) may be any material that will serve the function intended, whether it be merely functionality, or for esthetics, or for advertising a message on it whether by (engraving as for leather) or printing (as for paper, cardboard, vinyl or cloth.)

Surfaces (4) may be of any type wherever the need for an extra pocket could be found, such as at doorways, automobile dashboards, on a shirt, refrigerators . . . etc . . .

There may be a series of overlapping pockets (1) on a common backing (2).

1- A method for providing an extra pocket wherever need, using a means of affixing said pocket to a surface.

2- The method of claim 1, whereby peeling off the protective sheet from an adhesive medium (3) on the backng (2) sticking the pocket wherever one needs an extra pocket

3- The method of claim 1, whereby said pocket may have messages printed or embossed or engraved across the front, whereby it will provide an effective advertising medium

4- The method of claim 1, whereby said pocket may be made in a fashionable and esthetic mode as a fashion accessory.

5- The method of claim 1, whereby an variety of materials can be used to make the pockets such as leather, paper, cardboard, cloth, vinyl and plastics (either flexible or rigid) and as well as metals.

6- The method of claim 1, whereby said means for affixing said pocket, may comprise of items coming from a group that includes Velcro, glues and magnets.

7- The method of claim 1, whereby said means for affixing said pocket may be of a temporary or of a more permanent method.

8- An instrument for holding items comprising:
a. a pocket affixed to a backing that can be made to stick anywhere that a pocket is needed.

9- The instrument of claim 8, whereby peeling off the protective sheet from an adhesive medium (3) on the backng (2) sticking the pocket wherever one needs an extra pocket

10- The instrument of claim 8, whereby said pocket may have messages printed or embossed or engraved across the front, whereby it will provide an effective advertising medium

11- The instrument of claim 8, whereby said pocket may be made in a fashionable and esthetic mode as a fashion accessory.

12- The instrument of claim 8, whereby an variety of materials can be used to make the pockets such as leather, paper, cardboard, cloth, vinyl and plastics (either flexible or rigid) and as well as metals.

13- The instrument of claim 8, whereby said means for affixing said pocket, may comprise of items coming from a group that includes Velcro, glues and magnets.

14- The instrument of claim 8, whereby said means for affixing said pocket may be of a temporary or of a more permanent method.
